(19) United States
(12) Patent Application Publication
(10) Pub. No.: US 2006/0171669 A1
(43) Pub. Date: Aug. 3, 2006

(54) Video data recording and playing device

(75) Inventor: Tekeshi Kaminosono, Daito-shi (JP)

Correspondence Address: GLOBAL IP COUNSELORS, LLP, 1233 20TH STREET, NW, SUITE 700, WASHINGTON, DC, 20036-2680, US

(73) Assignee: FUNAI ELECTRONIC CO., LTD., Daito-shi (JP)

(21) Appl. No.: 11/332,514

(22) Filed: Jan. 17, 2006

(30) Foreign Application Priority Data
Jan. 14, 2005 (JP) 2005-007436

(51) Int. Cl. H04N 5/91

(52) U.S. Cl. 386/83

(57) ABSTRACT

A video data recording and playing device includes: a first recording unit adapted to record and read data on and from a first recording medium; a second recording unit adapted to record and read data on and from a second recording medium; and a control unit operatively connected to the first and second recording units and configured to selectively start and finish the recording by the first and second recording units. The first recording unit is further configured to detect a recording error that is due to a defect in the first recording medium and occurs while the first recording unit records data on the first recording medium. The control unit is configured to start recording data with the second recording unit on the second recording medium when the first recording unit detects a recording error while the first recording unit records the data on the first recording medium.

### FIELD OF THE INVENTION

The present invention relates to a video data recording and playing device. More specifically, the present invention relates to video data recording and playing devices such as DVD recorders and video cassette recorders.

### BACKGROUND INFORMATION

DVD (digital versatile disk) is a high capacity recording medium for recording images as digital signals, and has become widely popular today in conjunction with DVD recorders due its compact format and its capability of playing sharp images, as well as the ease of editing such images. Video cassette tape, on the other hand, is a recording medium for recording images as analog signals, and is still widely used in households today together with video cassette recorders, although it lacks the high capacity and the image quality of the DVD format. Accordingly, diverse video recording devices have been developed and are available commercially, including multi function machines incorporating a DVD recorder function and a video cassette recorder function, and multi function machines incorporating a DVD recorder function and a video cassette recorder function as well as a television function.

In such video data recording and playing devices, there are cases in which images are not recorded properly due to conditions of the recording medium. Such failure to record typically occurs with an optical disk such as a DVD. When an image is to be recorded in a DVD with a DVD recorder, a predetermined operation is performed on the DVD that is loaded to the DVD recorder body, prior to starting the image recording. However, when the DVD is deformed or scratched or otherwise damaged, the recording on the disk surface by laser light is not performed normally, and recording errors occur. As a result, the desired program cannot be recorded, and the user experiences an unexpected loss.

In view of the above, it will be apparent to those skilled in the art from this disclosure that there exists a need for an improved video data recording and playing device that overcomes the above described problem. This invention addresses this need in the art as well as other needs, which will become apparent to those skilled in the art from this disclosure.

### SUMMARY OF THE INVENTION

The present invention provides a video data recording and playing device that is capable of recording data on a second recording medium when a recording error occurs to the recording of data on a first recording medium.

The video data recording and playing device of an aspect of the present invention includes a first recording unit adapted to record and read data on and from a first recording medium; a second recording unit adapted to record and read data on and from a second recording medium; and a control unit operatively connected to the first and second recording units and configured to selectively start and finish the recording by the first and second recording units. The first recording unit is further configured to detect a recording error that is due to a defect in the first recording medium and occurs while the first recording unit records data on the first recording medium. The control unit is configured to start recording data with the second recording unit on the second recording medium when the first recording unit detects a recording error while the first recording unit records the data on the first recording medium.

Here, when a determining means determines that data cannot be recorded to a recording medium due to a defect of the first recording medium or the first recording medium being full, the control unit records the image on a second recording medium by with the second recording unit, such that the data of a desired program or the like can be continuously recorded on the second recording medium from the point at which the recording error occurred while recording with the first recording unit on the first recording medium. Therefore, the user can watch or listen to the recorded data up to the point of the recording error by playing the first recording medium, and watch or listen to the data subsequent to the recording error by playing the second recording medium.

In the video data recording and playing device, the control unit is preferably configured to allow a user to select a backup recording mode, the control unit being configured not to start recording the data with the second recording unit on the second recording medium if the backup recording mode is not selected even when the recording error is detected during the recording by the first recording unit. In this way, a user can select to activate or not to activate the backup recording. Particularly, if the user selects not to activate the backup recording, it is possible to avoid writing over the content previously recorded on the second recording medium.

In the video data recording and playing device, the control unit is preferably configured to start recording the data with the second recording unit on the second recording medium when the recording error is detected during the recording by the first recording unit only if the backup recording mode is selected and if the control unit determines that the second recording medium is ready for recording. In this way, the backup recording is performed only when the two conditions are satisfied.

In the video data recording and playing device, the control unit is preferably further configured to allow the user to set, at a time selection screen, a time at which the recording with the first recording unit starts automatically. The control unit is also preferably configured to indicate whether the backup recording mode is selected in the timer selection screen. In this way, a user can confirm whether or not to activate the backup recording before the timer recording, thereby allowing the user to avoid erroneously erasing the content recorded on the second recording medium.

In the video data recording and playing device, the control unit is configured to start recording the data with the second recording unit on the second recording medium when the recording error in the first recording unit is detected only if the backup recording mode is selected and if the control unit determines that the second recording medium is ready for recording. The control unit is configured to indicate in the time selection screen that the backup recording is unavailable if the control unit determines that the second recording medium is not ready for recording even though the backup recording mode is selected. In this way, it is possible to let the user know that the backup recording is unavailable even though the backup recording mode is selected, due to, for example, a recordable second recording medium not being loaded.

In the video data recording and playing device, the control unit is preferably configured to further indicate in the time selection screen a reason why the backup recording is unavailable when the backup recording is unavailable because the control unit determines that the second recording medium is not ready for recording even though the backup recording mode is selected. In this case, since the reason why the backup recording cannot be performed is displayed, the user can respond appropriately to remedy the problem.

In the video data recording and playing device, the control unit is configured to indicate that the backup recording is unavailable in different manners when the backup recording is unavailable because the control unit determines that the second recording medium is not ready for recording and when the backup recording is unavailable because the backup recording mode is not selected.

In the video data recording and playing device, the first recording unit further includes a buffer in which data to be recorded in the first recording medium are temporarily stored, and the control unit is configured to start recording data from the buffer with the second recording unit on the second recording medium when the recording error is detected during the recording by the first recording unit. Thus, recording on the second recording medium is possible immediately after the recording error occurs, even when there is a time lag from the time at which the recording error occurs until the time at which the backup recording actually starts.

In the video data recording and playing device, the first recording medium is preferably a DVD, and the first recording unit is preferably a DVD recorder.

In the video data recording and playing device, the second recording medium is preferably a video cassette tape, and the second recording unit is preferably a video cassette recorder.

In the video data recording and playing device, the second recording medium is preferably a hard disk, and the second recording unit is preferably a hard disk recorder.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a frontal external view of the video data recording and playing device in accordance with an embodiment of the present invention;

FIG. 2 is a block circuit diagram showing the electrical structure of the video data recording and playing device in accordance with the embodiment of the present invention;

FIG. 3 is a flow chart showing the operation during DVD recording in the video data recording and playing device in accordance with the embodiment of the present invention;

FIG. 4 is an example of a menu screen displayed on a monitor in the video data recording and playing device in accordance with the embodiment of the present invention;

FIG. 5 is an example of a setting screen for performing timer preset recording in the video data recording and playing device in accordance with the embodiment of the present invention;

FIG. 6 is an example of a setting screen for performing timer preset recording in the video data recording and playing device in accordance with the embodiment of the present invention; and

FIG. 7 is a block circuit diagram showing the electrical structure of the video data recording and playing device in accordance with an alternate embodiment of the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

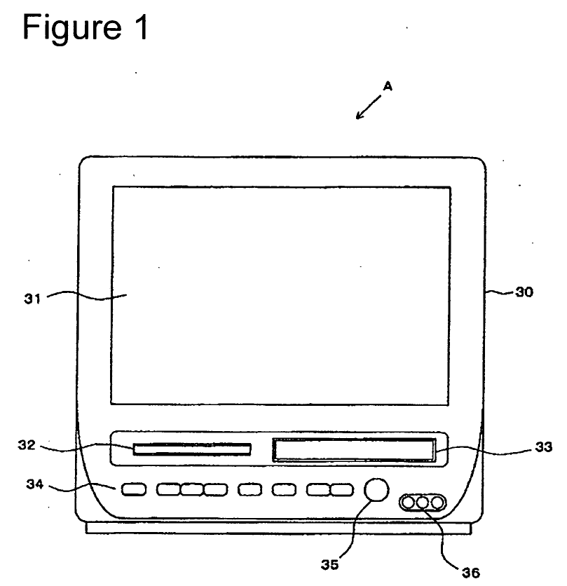

The embodiments of the present invention are described hereinafter with reference to the drawings. FIG. 1 is a frontal external view showing the video data recording and playing device of an embodiment of the present invention. A video data recording and playing device A is a multi function machine incorporating a television (hereinafter referred to as “TV”), a DVD recorder, and a video cassette recorder (hereinafter referred to as “VCR”). A television processes received broadcast signals and displays an image on a monitor 31. The DVD recorder and VCR are housed within the body 30 of the video data recording and playing device. A disk tray 32 is a part of the DVD recorder and is formed on the body 30 of the video data recording and playing device. The DVD recorder records and plays images on a DVD placed on the disk tray 32. An image played by the DVD recorder is displayed on the monitor 31. A tape insertion slot 33 is a part of the VCR and is formed on the body 30 of the video data recording and playing device. The VCR records and plays images on a video cassette tape inserted in the tape insertion slot 33. An image played by the VCR is displayed on the monitor 31. An operation unit 34 is provided with various operation buttons. A remote control receiver 35 is a receiver for receiving transmission signals from a remote control not shown in the drawing. An external input terminal 36 are connectors for connecting to an external device.

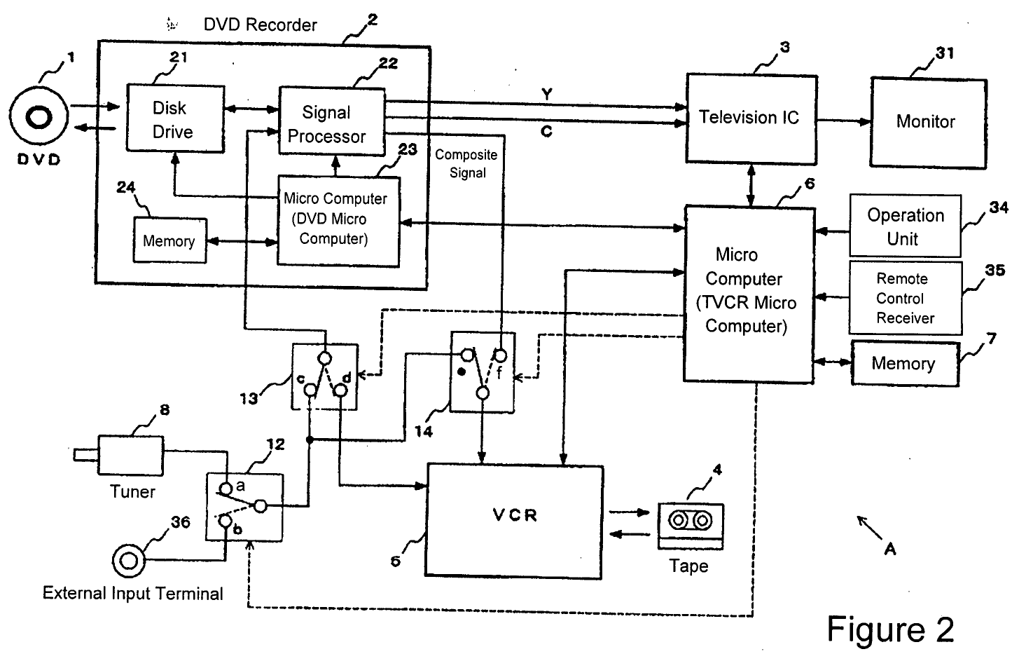

FIG. 2 is a block circuit diagram showing the electrical structure of the video data recording and playing device A. Only the part relating to the embodiment of the present invention is shown in the drawing. A DVD recorder 2 for recording and playing images on/from a DVD recording medium 1. A television integrated circuit (IC) 3 is for processing signals in order to display an image on the monitor 31 of the television body 30. A VCR 5 is for recording and playing images to and from a video cassette tape recording medium 4, which is for example a video cassette tape. A tuner 8 is for selecting broadcast signals of predetermined frequencies. The external input terminal 36 is also shown in FIG. 1. A micro computer 6 (an example of the control unit) is common to both the television and the VCR (hereinafter referred to as “TVCR micro computer”). A memory 7 is configured by ROM, RAM or the like. The remote control receiver 34 is also shown in FIG. 1. Reference numbers 1214 refer to switches for switching the signal path. Each switch is configured by an electronic switch that performs a switching operation based on commands (indicated by the dashed lines in the drawing) from the TVCR micro computer 6.

The TVCR micro computer 6 is operatively connected to the television IC 3, the VCR 5, and the micro computer 23 of the DVD recorder 2 to selectively control and operate any of the television IC 3, the VCR 5, and the DVD recorder 2. The TVCR micro computer 6 is also operatively connected to the operation unit 34, the remote control receiver 35, and the memory 7 so as to receive signals from the operation unit 34 and the remote control receiver 35, and receive and write data from and to the memory 7. The TVCR micro computer 6 is also operatively connected to the switches 12-14 to selectively switch any of the switches 12-14.

The micro computer 23 is operatively connected to the signal processing unit 22, the disk drive 21, and the memory 24 so as to selectively send signals to the processing unit 22 and the disk drive 21, and read and write data from and on the memory 24.

The DVD recorder 2 includes a disk drive 21 for recording and playing data on/from the DVD 1; a signal processing unit 22 for processing signals recorded to the DVD 1 by the disk drive 21 and signals read from the DVD 1 by the disk drive 21; a micro computer 23 for controlling the operation of the DVD recorder 2 (hereinafter referred to as “DVD micro computer), and a memory 24 such as a ROM, RAM or the like. Brightness signals Y and color signals C are output from the signal processing unit 22 to the television IC 3, and composite signals of the brightness signals Y and the color signals C are output through the switch 14 to the VCR 5.

The switches 12 and 13 are provided between the tuner 8 and the external input terminal 36 and the DVD recorder 2. When the switch 12 is turned to the “a” side and the switch 13 is turned to the “c” side, the image signals received by the tuner 8 are supplied through the switches 12 and 13 to the signal processing unit 22 of the DVD recorder 2. When the switch 12 is turned to the “b” side and the switch 13 is turned to the “c” side, the image signals input from the external input terminal 36 are supplied through the switches 12 and 13 to the signal processing unit 22 of the DVD recorder 2. In the signal processing unit 22, the image signals are subjected to predetermined signal processing, and the images are recorded to the DVD 1 by the disk drive 21.

The switches 13 and 14 are provided between the DVD recorder 2 and the VCR 5. When the switch 13 is turned to the “d” side, image signals played by the VCR 5 are supplied through the switch 13 to the signal processing unit 22, and the images are recorded to the DVD 1 by the disk drive 21. When the switch 14 is turned to the “f” side, composite signals output from the signal processing unit 22 are supplied to the VCR 5, and the VCR 5 records the signals on the video cassette tape 4. When the switch 14 is turned to the “e” side, an image signal from the tuner 8 or the external input terminal 36 is supplied to the VCR 5, and the VCR 5 records the signal to the video cassette tape 4.

In the above structure, the DVD 1 corresponds to the first recording medium of the present embodiment, the DVD recorder 2 corresponds to the first recording unit of the present embodiment, the video cassette tape 4 corresponds to the second recording medium of the present embodiment, the VCR 5 corresponds to the second recording unit of the present embodiment, the DVD micro computer 23 corresponds to the DVD micro computer of the present embodiment, the TVCR micro computer corresponds to the control unit of the present embodiment, and the memory 24 corresponds to the memory means of the present embodiment.

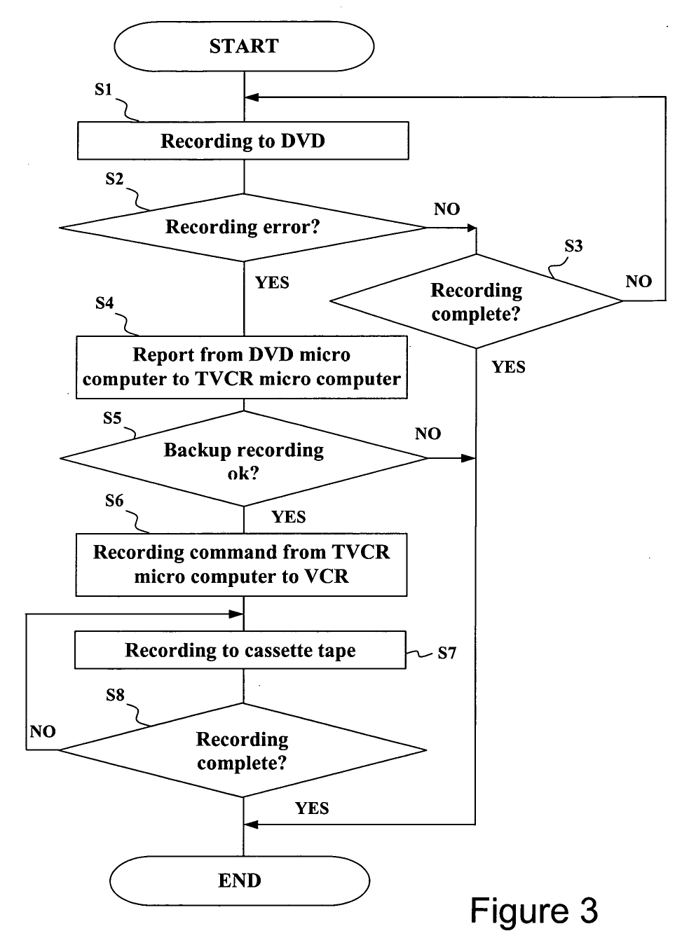

The operation described below pertains to the situation when a recording error occurs while recording an image to the DVD 1 due to a defect in the DVD 1. FIG. 3 is a flow chart showing the operation of the video data recording and playing device A during DVD image recording. In FIG. 2, the switch 12 is switched to the “a” side, the switch 13 is switched to the “c” side, and the switch 14 is switched to the “e” side. When the image recording operation to the DVD 1 is performed with the remote control (not shown in the drawing) or with the operation unit 34, then the image signals transmitted from the tuner 8 through the switches 12 and 13 are subjected to predetermined image processing in the signal processing unit 22 in the DVD recorder 2. Accordingly, the processed image signals are recorded to the DVD 1 by the disk drive 21 (step S1). Although the switch 14 is set to the “e” side at this time, image signals from the tuner 8 are not recorded to the video cassette tape 4 since a record command is not supplied from the TVCR micro computer 6 to the VCR 5.

After the image recording to the DVD 1 has started, the DVD micro computer 23 determines whether a recording error due to a defect in the DVD 1 such as a scratch or deformation or the like or the DVD 1 not having sufficient capacity has occurred (step S2). Since the manner in which a recording error is detected is well known in the art, detailed explanations thereof will be omitted herein. If there is no recording error during the image recording or a defect in the DVD 1, (step S2: NO), a determination is made as to whether or not there has been a command to end the image recording (step S3). If there has been a command to end the image recording (step S3: YES), the operation ends. On the other hand, when there has been no command to end the image recording (step S3: NO), the process returns to step S1 and the image recording continues.

When the image recording fails due to a defect in the DVD 1 or the DVD 1 being full in step S2 (step S2: YES), it is determined that a recording error occurred. Then, the DVD micro computer 23 notifies the TVCR micro computer 6 of the recording error (step S4).

Once the TVCR micro computer 6 has received the recording error notification, it determines whether or not backup recording by the VCR 5 is possible (step S5). Backup recording herein means to continue the image recording from this point to the video cassette tape 4 when the image recording to the DVD 1 has failed.

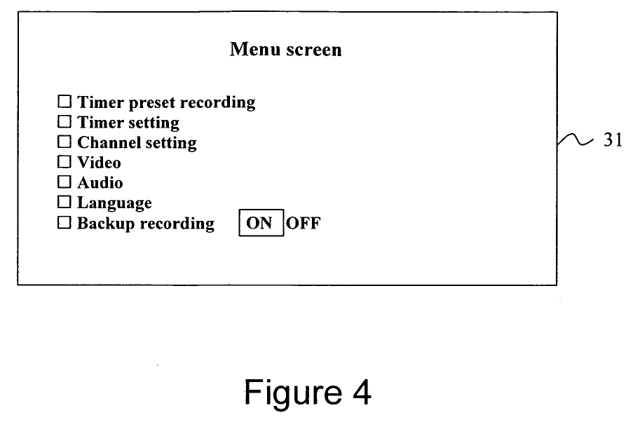

In the present embodiment, whether or not backup image recording is possible is determined based on two conditions. The first condition is whether or not there has been an initial configuration that allows the backup recording. FIG. 4 shows an example of a menu screen displayed on the monitor 31, in which the initial configuration is set so as to allow or not to allow the backup recording. In the example of FIG. 4, backup recording is set to ON, thereby allowing the backup recording. The second condition is whether or not a recordable video cassette tape 4 is loaded in the VCR 5. This condition is determined by detecting whether a video cassette tape 4 is inserted in the tape insertion slot 33, and whether there is an overwrite protection tab on the tape 4. That is, it is determined that a recordable tape is loaded when a video cassette tape 4 is detected and the overwrite protection tab is not removed from the tape 4.

When both conditions are satisfied, that is, when the execution of the initial configuration allows the backup recording and a recordable video cassette tape 4 is loaded in the VCR 5, the TVCR micro computer 6 determines that the backup recording is possible (step S5: YES). Then, the TVCR micro computer 6 sends a record command to the VCR 5 (step S6). However, if one or both of the two conditions is not satisfied (step S5: NO), the TVCR micro computer 6 determines that backup recording is not possible. Then, the process ends without the TVCR micro computer 6 sending a record command to the VCR 5.

When the VCR 5 receives a record command from the TVCR micro computer 6, recording is started to the video cassette tape 4 (step S7). Since the switch 14 is set to the “e” side at this time, the image signal from the tuner 8 is supplied through the switch 12 and the switch 14 to the VCR 5, and the VCR 5 records the image signal to the video cassette tape 4. Thus, the images subsequent to the recording failure that occurred in the DVD 1 can be recorded to the video cassette tape 4.

Then, a determination is made as to whether or not the image recording has ended (step S8). When it is determined that the image recording has not ended (step S8: NO), the process returns to step S7 and continues the image recording to the video cassette tape 4. When it is determined that the recording has ended (step S8: YES), the recording to the video cassette tape 4 ends and the operation ends.

In the present embodiment as described above, when recording is not possible due to a defect in DVD 1, the DVD micro computer 23 notifies the TVCR micro computer 6 of the recording failure, so that a record command is sent from the TVCR micro computer 6 to the VCR 5 to perform the backup recording to the video cassette tape 4. Therefore, the subsequent images of a desired program continue to be recorded to the video cassette tape 4 from the point at which the recording error occurred. Therefore, the user can hear and watch the recording by playing the DVD 1 up to the point where the recording error occurred, and then the rest of the program by playing the video cassette tape 4 from the point where recording error occurred in the DVD 1. Thus, the viewer can avoid the unexpected loss of not being able to record the complete program the viewer believed was recorded.

There is a concern of overwriting and erasing the contents that has been recorded in the tape 4 before the tape 4 is loaded, if the backup recording is configured to be performed unconditionally whenever the DVD 1 recording failure occurs. However, and a video cassette tape 4 is loaded which has already been recorded by the VCR 5, since whether or not to allow the backup recording can be set as the initial configuration in the present embodiment, the user can select whether or not to execute the backup recording by changing the initial configuration. In this manner, it is possible to avoid erroneously erasing the recorded content of the video cassette tape 4.

Recording to the DVD 1 often can be performed by a timer that is configured to start the recording automatically at a preset time. When using such timer preset recording, since the viewer is often not around the video data recording and playing device A when the preset time arrives, the viewer can only be notified of a recording error afterward if a recording error occurs the during recording as described above. Accordingly, the present invention such as the one in the above described embodiment can be particularly useful as a way to perform the automatic backup recording when a recording failure occurs during timer preset recording. In this case, it is very convenient for the user since it is displayed that backup recording is ongoing in the video data recording and playing device A.

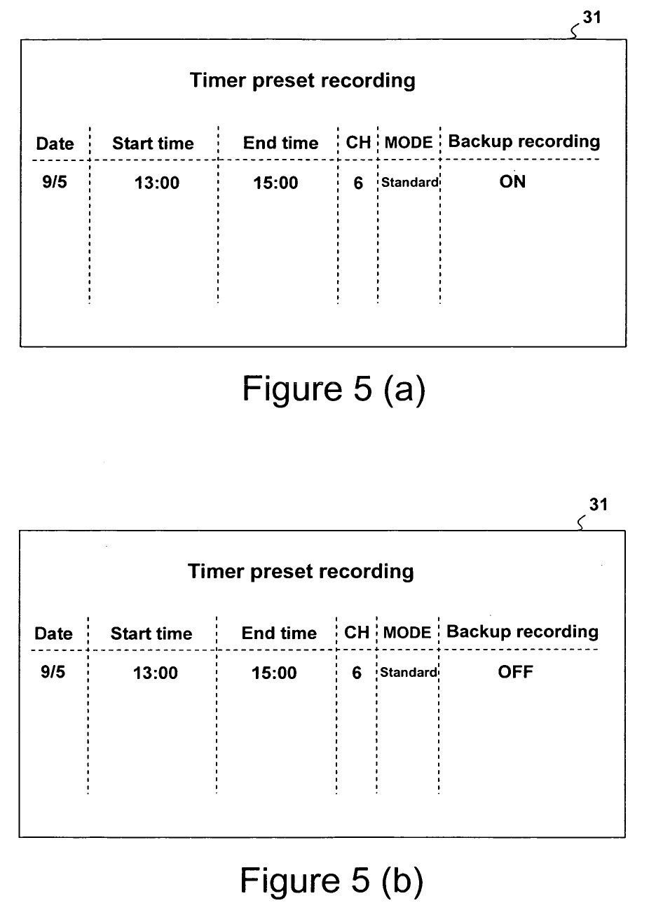

FIG. 5 shows a setting screen for timer preset recording. This screen is displayed when the timer preset recording is activated in the menu screen of FIG. 4. FIG. 5(a) shows a display that appears when the initial configuration of the backup recording is set to ON in the menu screen (FIG. 4), and shows that the backup recording column is set to [ON]. FIG. 5(b) shows a display that appears when the initial configuration of backup recording is set to OFF in the menu screen, and shows that the backup recording column is set to [OFF]. Thus, a user can reliably prevent erroneous erasure of recorded content on the video cassette tape 4 since the initial configuration of the backup recording is displayed on the setting screen for timer preset recording, and the user can verify whether or not the backup recording is to be performed.

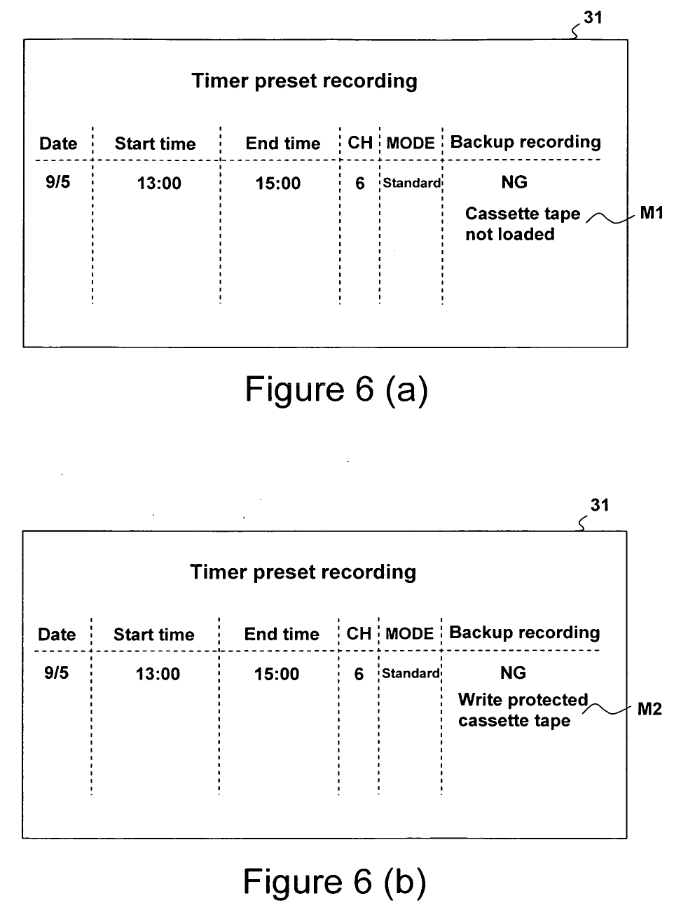

FIG. 6 shows the setting screens (example of time selection screen) for the timer preset recording indicating that the backup recording cannot be performed although the backup recording is set to ON in the menu screen of FIG. 4. FIG. 6(a) shows a display example when a video cassette tape 4 is not loaded. As seen in FIG. 6(a), [NG] is displayed in the backup recording column indicating that recording is not possible, and the reason why the recording is not possible is displayed in a message M1. FIG. 6(b) shows a display example when a video cassette tape 4 is loaded but recording is not possible because the overwrite protection tab has been removed to write protect the tape. As seen in FIG. 6(b), [NG] is displayed in the backup recording column indicating that recording is not possible, and the reason that recording is not possible is displayed in a message M2.

In this manner, by displaying [NG] as opposed to [OFF] as shown in FIG. 5(b), the user is notified that the backup recording is set to ON at the initialization configuration but the backup recording is not possible. Furthermore, since the user is also notified of why the backup recording is not possible by displaying the messages M1 and M2, the user can take appropriate action. Although the sign [NG] is used in the example of FIG. 6, it is possible alternatively to show [OFF] in a color different from that of [OFF] of FIG. 5. In either embodiment, the user can tell apart why the backup recording is unavailable.

The present invention is applicable to various embodiments other than those described above. For example, although an example of a recording error that occurs during image recording is provided in the above embodiment, the present invention is also applicable when an error occurs because the TOC (table of contents) information cannot be read from a DVD 1 due to a defect therein, that is, when recording to the DVD 1 is impossible from the beginning.

Although the image signals are supplied from the tuner 8 and the external input terminal 6 and directly recorded to the video cassette tape 4 during the backup recording in the above embodiment, the composite signals from the DVD recorder 2 may also be recorded to the video cassette tape 4 during the backup recording. In this case, the switch 14 is turned to the “f” side.

Although the first recording medium is a DVD and first recorder is a DVD recorder, and the second recording medium is a video cassette tape and the second recorder is a VCR in the above embodiments, the present invention is also applicable when the second recording medium is a hard disk and the second recorder is a hard disk recorder. In other words, the present invention is also applicable to a multi function machine incorporating a DVD recorder and a hard disk as an integrated unit

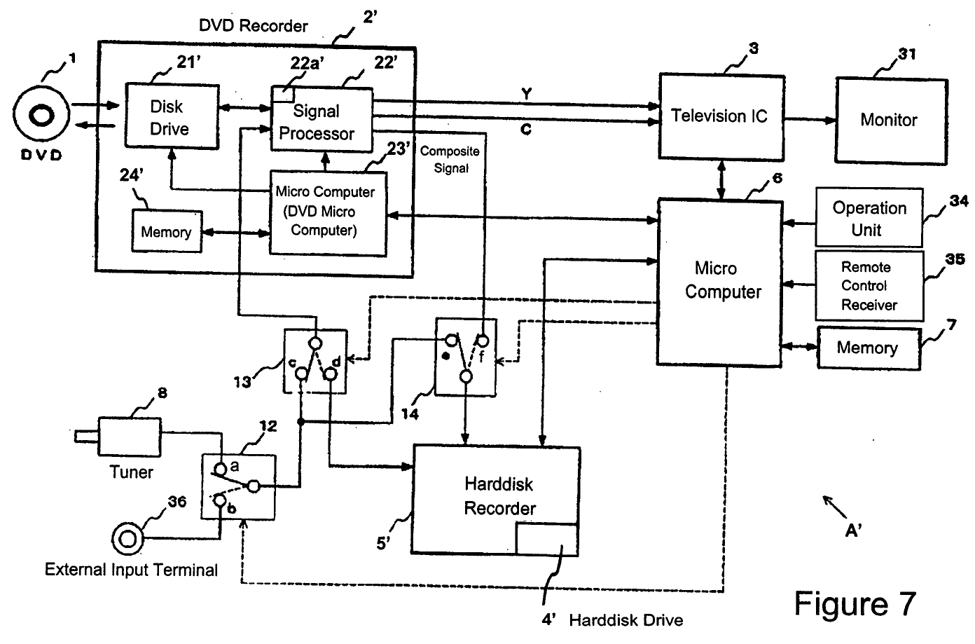

Furthermore, as shown in FIG. 7, a buffer 22a′ can be provided in the DVD recorder 2′ as a memory means for temporarily storing the data for recording to the DVD 1 received from the tuner 8 or the external input terminal 36. In the embodiment shown in FIG. 7, when a recording error occurs, the data stored in the buffer 22a′ can be sequentially read by the signal processor 22′ of the DVD recorder 2′ from the point at which the recording error occurred. Then, the data read from such buffer 22a′ can be transferred to the hard disk recorder 5′ from the signal processing unit 22′ as composite signals, such that these composite signals can be recorded to the hard disk drive 4′. Although the buffer 22a′ is provided in the signal processing unit 22′ in FIG. 7, the buffer 22a′ may alternatively be provided in the memory 24′ as well.

Since there is some time lag between the time at which the recording error occurs and the time at which the actual backup recording starts, there is a possibility that the data cannot be recorded to the video cassette tape 4 during this time lag. However, with the construction that utilizes the buffer, it is possible to record the data to the video cassette tape 4 immediately after the recording. In this construction, recording to the video cassette tape 4 is performed as a time shift recording, which records data that are shifted slightly time-wise from the actually broadcast data.

Although initialization configuration of the backup recording are performed in the menu screen of FIG. 4 in the above embodiment, the initialization configuration of the backup recording also may be performed in the setting screen of the timer preset recording shown in FIG. 5.

Although the example in the embodiments described above pertains to a multi function machine that incorporates a television, DVD recorder, and VCR as an integrated unit, the present invention is also applicable to a multi function machine incorporating only a DVD recorder and VCR as a single unit, or only a DVD recorder and a hard disk recorder as a single unit.

The term “video data” as used in this specification includes any streaming data such as visual, audio, and/or textual data.

As used herein, the following directional terms “forward, rearward, above, downward, vertical, horizontal, below and transverse” as well as any other similar directional terms refer to those directions of a device equipped with the present invention. Accordingly, these terms, as utilized to describe the present invention should be interpreted relative to a device equipped with the present invention.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

This application claims priority to Japanese Patent Application No. 2005-007436. The entire disclosure of Japanese Patent Application No. 2005-007436 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A video data recording and playing device, comprising:
a first recording unit adapted to record and read data on and from a first recording medium;
a second recording unit adapted to record and read data on and from a second recording medium; and
a control unit operatively connected to the first and second recording units and configured to selectively start and finish the recording by the first and second recording units,
the first recording unit being configured to detect a recording error that is due to a defect in the first recording medium and occurs while the first recording unit records data on the first recording medium, the control unit being configured to start recording data with the second recording unit on the second recording medium when the first recording unit detects a recording error while the first recording unit records the data in the first recording medium.

2. The video data recording and playing device of claim 1, wherein
the control unit is configured to allow a user to select a backup recording mode, the control unit being configured not to start recording the data with the second recording unit on the second recording medium if the backup recording mode is not selected even when the recording error is detected during the recording by the first recording unit.

3. The video data recording and playing device of claim 2, wherein
the control unit is configured to start recording the data with the second recording unit on the second recording medium when the recording error is detected during the recording by the first recording unit only if the backup recording mode is selected and if the control unit determines that the second recording medium is ready for recording.

4. The video data recording and playing device of claim 2, wherein
the control unit is further configured to allow the user to set, at a time selection screen, a time at which the recording with the first recording unit starts automatically, and
the control unit is configured to indicate whether the backup recording mode is selected in the timer selection screen.

5. The video data recording and playing device of claim 4, wherein
the control unit is configured to start recording the data with the second recording unit on the second recording medium when the recording error in the first recording unit is detected only if the backup recording mode is selected and if the control unit determines that the second recording medium is ready for recording, and
the control unit is configured to indicate in the time selection screen that the backup recording is unavailable if the control unit determines that the second recording medium is not ready for recording even though the backup recording mode is selected.

6. The video data recording and playing device of claim 5, wherein
the control unit is configured to further indicate in the time selection screen a reason why the backup recording is unavailable when the backup recording is unavailable because the control unit determines that the second recording medium is not ready for recording even though the backup recording mode is selected.

7. The video data recording and playing device of claim 5, wherein
the control unit is configured to indicate that the backup recording is unavailable in different manners when the backup recording is unavailable because the control unit determines that the second recording medium is not ready for recording and when the backup recording is unavailable because the backup recording mode is not selected.

8. The video data recording and playing device of claim 1, wherein
the first recording unit further includes a buffer in which data to be recorded in the first recording medium are temporarily stored, and
the control unit is configured to start recording data from the buffer with the second recording unit on the second recording medium when the recording error is detected during the recording by the first recording unit.

9. The video data recording and playing device of claim 1, wherein
the first recording medium is a DVD, and the first recording unit is a DVD recorder.

10. The video data recording and playing device of claim 9, wherein
the second recording medium is a video cassette tape, and the second recording unit is a video cassette recorder.

11. The video data recording and playing device of claim 9, wherein
the second recording medium is a hard disk, and the second recording unit is a hard disk recorder.

12. A video data recording and playing device, comprising:
a television receiver;
a DVD recorder having a DVD micro computer and a disk drive, the DVD recorder being adapted to record data received by the television receiver on a DVD recording medium and read data from the DVD recording medium with the disk drive;
a video cassette recorder adapted to record data received by the television receiver on a video cassette and read data from the video cassette; and
a control unit operatively connected to the DVD recorder and the video cassette recorder and configured to selectively start and finish the recording by the DVD recorder and the video cassette recorder,
the DVD micro computer being configured to detect a recording error that is due to a defect in the DVD recording medium and occurs while the DVD recorder records data on the DVD recording medium, the DVD micro computer being also configured to notify the recording error to the control unit,
the control unit being configured to allow a user to select a backup recording mode, the control unit being configured to start recording the data with the video cassette recorder on the video cassette when the recording error is detected during the recording by the DVD recorder only if the backup recording mode is selected and if the control unit determines that the video cassette is ready for recording.
